(19) United States
(12) Patent Application Publication
(10) Pub. No.: US 2026/0189985 A1
(43) Pub. Date: Jul. 2, 2026

(54) SOURCE DEVICE AND OPERATING METHOD THEREOF

(71) Applicant: SAMSUNG ELECTRONICS CO., LTD., Suwon-si (KR)

(72) Inventors: Chanho JUNG, Suwon-Si (KR); Kabkyun JEONG, Suwon-si (KR); Hyungyong LEE, Suwon-si (KR); Jehwan SEO, Suwon-si (KR); Junhan PARK, Suwon-si (KR); Yongjin KANG, Suwon-si (KR)

(73) Assignee: SAMSUNG ELECTRONICS CO., LTD., Suwon-si (KR)

(21) Appl. No.: 19/542,314

(22) Filed: Feb. 17, 2026

Related U.S. Application Data
(63) Continuation of application No. PCT/KR2026/000663, filed on Jan. 12, 2023.

(30) Foreign Application Priority Data
Jan. 10, 2025 (KR) 10-2025-0004219

(51) Int. Cl. H04W 28/22; H04L 65/80; H04W 84/12

(52) U.S. Cl. CPC H04W 28/22; H04L 65/80; H04W 84/12

(57) ABSTRACT

A source device and an operating method thereof are provided. The source device includes a wireless communication module that supports direct communication with a display device, at least one processor, and memory including one or more storage media storing one or more instructions. The source device identifies a first quantity of media packets generated to transmit media data to the display device, identifies a second quantity of media packets indicating a number of media packets transmitted to the display device through the wireless communication module, and adjusts the bitrate of the media data based on the difference between the first quantity and the second quantity.

### CROSS-REFERENCE TO RELATED APPLICATIONS

This application is a Continuation Application of International Application PCT/KR2026/000663 filed on Jan. 12, 2026, which claims benefit of Korean Patent Application No. 10-2025-0004219, filed on Jan. 10, 2025, at the Korean Intellectual Property Office, the disclosures of which are incorporated herein in their entireties by reference.

### FIELD

The disclosure relates to a source device and an operating method of the source device.

### BACKGROUND

Wireless connection services for wirelessly connecting a source device, which shares a screen image, and a sink device, which receives the screen image, have been researched. The source device may generate or transmit content. The sink device may be connected to the source device to receive and output the content from the source device.

The source device may receive and process various input signals to transmit content to a display device that is an example of the sink device. The input signal may include video, audio, or added information. The source device may have external source devices connected to itself and process and transmit the input signals to a display device wirelessly. For example, the source device may receive digital broadcast signals (DTVs or digital TVs) or analog broadcast signals (ATV or analog TVs), and digitize and transmit the signals to the display device through a broadcast network. For example, the source device may be connected to external source devices in a wired manner, and may receive input signals from the external source devices in a wired manner and process and transmit the input signals to the display device wirelessly. Accordingly, the source device may transmit high-resolution video and audio data to the display device without other wired connections such as a high-definition multimedia interface (HDMI) cable or a universal serial bus (USB). The display device may output content received from the source device through the display.

### SUMMARY

A source device according to an embodiment of the disclosure includes a wireless communication module that supports direct communication with a display device, at least one processor, and memory including one or more storage media storing one or more instructions.

The at least one processor according to an embodiment of the disclosure individually or collectively executes the one or more instructions to cause the source device to identify a first quantity of media packets generated to transmit media data to the display device.

The at least one processor according to an embodiment of the disclosure individually or collectively executes the one or more instructions to cause the source device to identify a second quantity of the media packets indicating a number of media packets transmitted to the display device through the wireless communication module.

The at least one processor according to an embodiment of the disclosure individually or collectively executes the one or more instructions to cause the source device to adjust the bitrate of the media data based on a difference between the first quantity and the second quantity.

An operating method of a source device according to an embodiment of the disclosure includes identifying a first quantity of media packets generated to transmit media data to a display device, identifying a second quantity of the media packets indicating a number of the generated media packets transmitted to the display device, through a wireless communication module that supports direct communication with the display device, and adjusting the bitrate of the media data based on the difference between the first quantity and the second quantity.

In an embodiment of the disclosure, provided is a computer-readable recording medium having a program recorded thereon for causing a computer to execute an operating method of the source device.

### BRIEF DESCRIPTION OF DRAWINGS

FIG. 1 is a schematic diagram illustrating a system including a source device and a display device both supporting a wireless connection service, according to an embodiment of the disclosure.

FIG. 2 is a diagram illustrating a network stack structure used in a source device according to an embodiment of the disclosure.

FIG. 3 is a configuration block diagram of a source device and display device according to an embodiment of the disclosure.

FIG. 4 is a flowchart for describing an operating method of the source device, according to an embodiment of the disclosure.

FIG. 5 is a flowchart for describing an operating method in which a source device transmits media data by using a network stack structure, according to an embodiment of the disclosure.

FIG. 6 is a diagram illustrating an operation of transceiving media data between a source device and a display device via a network, according to an embodiment of the disclosure.

FIG. 7 is a diagram illustrating an operation of a source device and a display device in a network stack structure, according to an embodiment of the disclosure.

FIG. 8 is a diagram illustrating a shape of a packet corresponding to the network stack structure, according to an embodiment of the disclosure.

FIG. 9 is a flowchart for describing an operating method of transceiving media data via a network between a source device and a display device, according to an embodiment of the disclosure.

FIG. 10 is a system block diagram of a source device and a display device, according to an embodiment of the disclosure.

### DETAILED DESCRIPTION

In the disclosure, expressions such as “at least one of a, b, or c” may denote “a,” “b,” “c,” “a and b,” “a and c,” “b and c,” “all of a, b, and c,” or modifications thereof.

Hereinafter, the disclosure will be described more fully with reference to the accompanying drawings, in which embodiments of the disclosure of the disclosure are shown. This disclosure may, however, be embodied in many different forms and should not be construed as limited to the embodiments of the disclosure set forth herein.

The terms used in the disclosure have been selected from currently widely used general terms in consideration of the functions in the disclosure. However, the terms may vary according to the intention of one of ordinary skill in the art, case precedents, and the advent of new technologies. Accordingly, the terms used in the disclosure are defined based on their meanings in relation to the contents discussed throughout the specification, not by their simple meanings.

Furthermore, terms used in the disclosure are used for explaining a specific embodiment of the disclosure, not for limiting the disclosure.

in the disclosure, when a component “connects” or is “connected” to another component, the component contacts or is connected to the other component not only directly, but also electrically through at least one of other components interposed therebetween.

In the specification, in particular, the claims, the use of the terms “a,” “an,” “the,” and similar referents in the context of describing the disclosure is to be construed to cover both the singular and the plural. Furthermore, the operations of all methods described herein can be performed in any suitable order unless otherwise indicated herein or otherwise clearly contradicted by context. The disclosure is not limited to the described order of the operations.

In the specification, expressions such as “in some embodiments of the disclosure” or “in an embodiment of the disclosure” appearing in various places in the disclosure do not necessarily indicate the same embodiment of the disclosure.

The disclosure may be described in terms of functional block components and various processing steps. Such functional blocks may be realized by any number of hardware and/or software components configured to perform the specified functions. For example, the functional blocks of the disclosure may be implemented by one or more microprocessors, or by circuitry configurations for a predetermined function. Furthermore, for example, the functional blocks of the disclosure may be implemented in various programming or scripting languages. The functional blocks may be implemented as algorithms running on one or more processors. Furthermore, the disclosure may employ conventional technologies for electronic environment setting, signal processing, and/or data processing, and the like. The words “mechanism,” “element,” “means,” and “configuration” are used broadly and are not limited to mechanical or physical embodiments of the disclosure.

Furthermore, connection lines or connection members between the components shown in the drawings are merely illustrative of functional connections and/or physical or circuitry connections. In an actual device, a connection between the components may be indicated by various functional connections, physical connections, or circuitry connections that can be replaced or added.

Furthermore, in the disclosure, a “module” or “portion” may perform at least one of functions or operations, and may be implemented by hardware, software, or a combination of hardware and software.

In the disclosure, the “processor” may include various processing circuitry and/or a plurality of processors. For example, the term “processor” used herein including the claims may include various processing circuitry including at least one processor. In the at least one processor, one or more processors may be configured to perform various functions described herein in a dispersion fashion individually and/or collectively. As used herein, “a processor,” “at least one processor,” or “one or more processors” may be configured to perform various functions. However, these terms may cover, without limitation, situations in which one processor performs some of functions and another processor or processors perform the others of the functions, as well as situations in which a single processor performs all of the functions. Furthermore, at least one processor may comprise a combination of processors that perform various functions disclosed in a dispersion fashion. The at least one processor may execute program instructions to achieve or perform various functions.

In the disclosure, the term “user” refers to a person who uses a display device, and may include a consumer, an evaluator, a viewer, an administrator, or an installer. Furthermore, in the specification, a “manufacturer” or a “provider” may refer to a manufacturer who manufactures a display device and/or a component included in the display device.

In the disclosure, an “image” may include a still image, a graphic, a picture, a frame, a motion picture including a plurality of continuous still images, or a video.

In the disclosure, a “communication path” may refer to a physical or logical path through which data is transmitted from a transmitter TX to a receiver RX. For example, the communication path may refer to a routing path on a network or a physical network connection. For example, in a Wi-Fi Direct (WFD) connection, the communication path may refer to a wireless communication path between two devices. For example, in an inter-device connection relayed by an access point (AP), the communication path may refer to a physical connection path or wireless communication path between two devices.

In the disclosure, Wi-Fi Direct is a peer-to-peer (P2P) communication method (or a device-to-device (D2D) communication method), which may refer to a method in which two devices are directly connected without passing through an AP. For example, the Wi-Fi Direct may transceive data based on TCP/IP communication.

In the disclosure, a device for providing a wireless connection service transmits data generated by a user program by attaching a communication protocol header to the data in order to transceive packets. A general communication protocol header may include, for example, an internet protocol (IP) and a transmission control protocol (TCP)/a user datagram protocol (UDP) and an Ethernet header.

In the disclosure, in an open systems interconnection (OSI) 7-layer, an application program that is a high layer generates data to transmit and transmits the data to a lower layer, and this process operates differently depending on an operating system (OS).

In the disclosure, the OS may refer to system software that manages the hardware and software resources of a computing device and provides common services for programs (processes). The OS acts as an interface between a user and hardware, enabling various application programs to use the hardware efficiently.

In the disclosure, the OS may operate in a dual mode including a user mode and a kernel mode. The user mode, which is an execution mode in which OS services are not provided, is a mode in which it is unable to execute the code of a kernel area. The application program is executed in the user mode. The application program executed in the user mode may not access the hardware resources. The kernel mode, which is an execution mode in which the OS services are provided, is a mode in which it is possible to execute the code of the kernel area. When a processor executes instructions in the kernel mode, it is possible to access the hardware resources.

In the disclosure, packetization may include an operation of dividing data into small units of packets and creating the data in the form of packets by adding a header containing information about the data. In the disclosure, de-packetization may include an operation that analyzes (or parses) the information contained in the packet′s header to extract the data contained within the packet.

In the disclosure, multiplexing or muxing may include an operation of converting independent data such as video, audio, or subtitles into one transmission stream. In the disclosure, demultiplexing or demuxing may include an operation of separating data such as video, audio, or subtitles contained in one transmission stream.

In the disclosure, streaming data refers to a continuous flow of data generated from various sources. The source device may divide streaming data into small media file chunks, packets, or segments and transmit the same to the sink device.

In the disclosure, content may be one that a device receives from a content provider, such as broadcast signals, streaming services, Blu-ray players, or game consoles. The content may include one or more of broadcast content received directly from a broadcasting station as an RF signal, broadcast content received through an external source device, or content received from a content providing server via the Internet.

The disclosure is described below in detail with reference to the accompanying drawings.

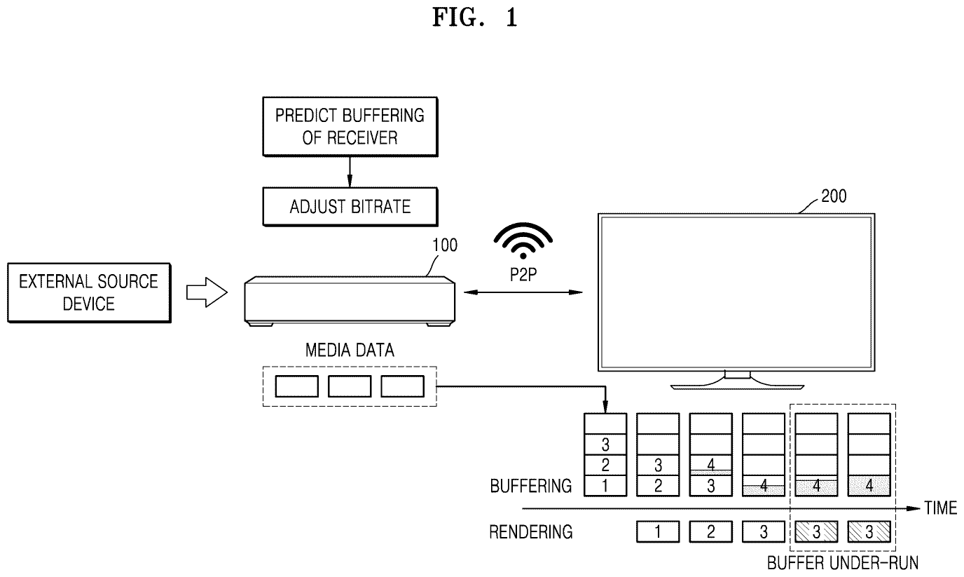

FIG. 1 is a schematic diagram illustrating a system including a source device and a display device both supporting a wireless connection service, according to an embodiment of the disclosure.

The system according to an embodiment of the disclosure may include the source device 100 and the display device 200. The system may provide a wireless connection service between the source device 100 and the display device 200. The display device 200 may correspond to a sink device. In the disclosure, the source device 100 may be referred to as a transmitter TX or a transmitting device. The display device 200 may be referred to as a receiver RX or receiving device.

The source device 100 according to an embodiment of the disclosure may include a set-top box, a Blu-ray disk player, a digital versatile disk (DVD) player, a game device, a digital camera, a camcorder, a streaming device, or a home theater. Alternatively, the source device 100 may include various electronic devices, such as smart phones, tablet personal computers (PCs), mobile terminals, video phones, e-book readers, desktop PCs, laptop PCs, netbook computers, personal digital assistants (PDAs), portable multimedia players (PMPs), navigation devices, MP3 players, or wearable devices.

The display device 200 according to an embodiment of the disclosure may be a TV, but this is merely an embodiment of the disclosure, and may be implemented by an electronic device capable of receiving a broadcast signal and displaying an image based on the broadcast signal. For example, the display device 200 may be implemented by various electronic devices, such as mobile phones, tablet PCs, digital cameras, camcorders, laptop computers, tablet PCs, desktop PCs, e-book readers, digital broadcast terminals, PDAs, PMPs, navigation devices, MP3 players, or wearable devices. In particular, embodiments of the disclosure may be easily implemented by display devices with large displays, such as TVs, but the disclosure is not limited thereto.

Furthermore, the display device 200 may be a fixed device or a movable device, and may be a digital broadcast receiver capable of receiving digital broadcast. Furthermore, the display device 200 may be implemented not only by flat display devices, but also by curved display devices having a fixed curvature or flexible display devices having an adjustable curvature. The output resolution of the display device 200 may include, for example, a high definition (HD), a full HD, an ultra HD, or a higher resolution than the ultra HD.

The source device 100 according to an embodiment of the disclosure may receive various contents from an external device. For example, the content may mean multimedia content and include images, video, audio, text, games, applications, or broadcast, but the disclosure is not limited thereto. For example, the source device 100 may receive broadcast content via a tuner unit through a broadcast network. The broadcast content may be various types of media including a collection of media components (e.g., video, audio, subtitles, service announcements, etc.) to be provided to a user. For example, the source device 100 may receive various contents from an external device through an input/output unit. For example, the source device 100 may receive various applications, for example, an over-the-top (OTT) content provided by an OTT service provider via a communication unit.

The source device 100 according to an embodiment of the disclosure may be connected to the display device 200 through a wireless communication network. The source device 100 may transmit received content to the display device 200. The display device 200 may receive content from the source device 100 and output the received content to a display. For example, the source device 100 may be directly connected to the display device 200 using an inter-device direct connection method.

When data is not appropriately transmitted from the source device 100 to the display device 200, a buffer under-run problem may occur in the display device 200. The buffer under-run problem may refer to a phenomenon that the receiver (e.g., the display device 200) does not sufficiently receive data to be reproduced from the transmitter (e.g., the source device 100) so that an image or audio is intermittently received. A buffer may refer to a space for temporarily storing received data. When the data stored in a buffer of the receiver is exhausted, image output or audio output may be stopped. For example, when the data stored in the buffer of the display device 200 is exhausted, the display device 200 may output a black image, repeatedly output a previously output image, or stop audio output. In other words, when data processing (e.g., rendering) is performed in a buffer under-run state in which the data in the buffer of the display device 200 is exhausted, a discontinuity problem of image reproduction of the display device 200 occurs.

FIG. 1 illustrates a case in which the display device 200 receives data 1, data 2, data 3, and data 4 from the source device 100. Each data may be in the form of packets, but the disclosure is not limited thereto. The display device 200 may receive data 1, data 2, and data 3 from the source device 100 at a constant speed and store the received data in the buffer. The display device 200 may render the data stored in the buffer and output an image and audio corresponding to data 1, data 2, and data 3. However, when the display device 200 does not smoothly receive data 4 from the source device 100, buffer under-run may occur in the display device 200 due to data 4. The display device 200 processes data 4 in the state in which data 4 is exhausted in the buffer, and thus the image output may be stopped.

In order to prevent the buffer under-run, the source device 100 may transmit data by lowering the bitrate of data, and thus the display device 200 is able to smoothly reproduce content with a less amount of data. A method in which the transmitter adjusts the bitrate of data according to the buffering state of the receiver and transmits the adjusted data to the receiver may be referred to as adaptive bitrate (ABR) streaming.

In the disclosure, the bitrate may indicate a speed of transmitting or processing data, and may refer to an amount of data transmitted for one second. The bitrate is expressed by bits per second (bps). Lowering the bitrate may refer to reducing an amount of data transmitted for one second (bitrate). For example, a case is shown in which, for an image configured with 60 frames per second, an encoder compresses the image at a bitrate set to 60 Mbps. When the bitrate of a video having a bitrate set to 60 Mbps is reduced by 30%, the bitrate may be reduced to 42 Mbps. In this case, the encoder may compress the image configured with 60 frames per second at a bitrate of 0.7 Mbps per frame, not 1 Mbps per frame.

In order to adjust the bitrate of an image, the source device 100 may identify resolution information or data compression ratio information of an image corresponding to the adjusted bitrate, and adjust the resolution or data compression ratio of the image according to the identified resolution information or data compression ratio information. For example, in order to reduce the bitrate of an image, the source device 100 may identify the resolution information of an image corresponding to the reduced bitrate. The source device 100 may reduce the resolution of an image by using the identified resolution information. For example, in order to reduce the bitrate of an image, the source device 100 may identify data compression ratio information corresponding to the reduced bitrate. The source device 100 may increase the data compression ratio of an image by using the identified data compression ratio information.

The reasons for the insufficiency of data in the buffer of the display device 200 may include a case in which a network state between the source device 100 and the display device 200 is unstable, a case in which packets are not transmitted and accumulated in each layer in a network stack of the source device 100, or a central processing unit (CPU) overload state. For example, when the network state between the source device 100 and the display device 200 is unstable, while a quantity (first quantity) of packets prepared (or generated) for transmitting data by the source device 100 is 100 units, a quantity (second quantity) of packets actually transmitted from the source device 100 to the display device 200 may be 80 units. In this case, the difference between the first quantity and the second quantity, which amounts to 20 units, may not transmitted to the display device 200 and may be accumulated in each layer in the network stack of the source device 100. The buffer of the display device 200 lacks data by 20 packets. The buffer of the display device 200 may have a remaining space as much as 20 packets. Alternatively, when each of the source device 100 and the display device 200 is in a CPU overload state, similarly, the first quantity and the second quantity may be different from each other.

The source device 100 may predict the buffering state of the display device 200 that is the receiver by identifying the difference between the first quantity and the second quantity. The source device 100 may adjust in real time the bitrate of data (streaming quality) depending on the buffering state of the display device 200. When there is not enough data in the buffer of the display device 200 (i.e., when the buffer under-run is imminent), the source device 100 may reduce the bitrate. When there is sufficient data in the buffer of the display device 200, the source device 100 may increase or maintain the bitrate. When the bitrate is changed to a low bitrate, a data transmission rate decreases, and thus a network bandwidth may be used less. Accordingly, by adjusting the bitrate, without the buffer under-run problem in the display device 200, the continuity in the image reproduction may be maintained.

In the inter-device direct connection method according to an embodiment of the disclosure, the source device 100 may identify the first quantity and the second quantity to predict whether packets have been appropriately transmitted to the display device 200. In other words, the source device 100 may identify the remained size (or remaining space) of the buffer of the display device 200, in real time, without receiving without receiving separate feedback from the display device 200. The source device 100 may adjust the bitrate by predicting the buffering state of the display device 200. The source device 100 may prevent the buffer under-run of the display device 200 and provide a user with an image with continuity.

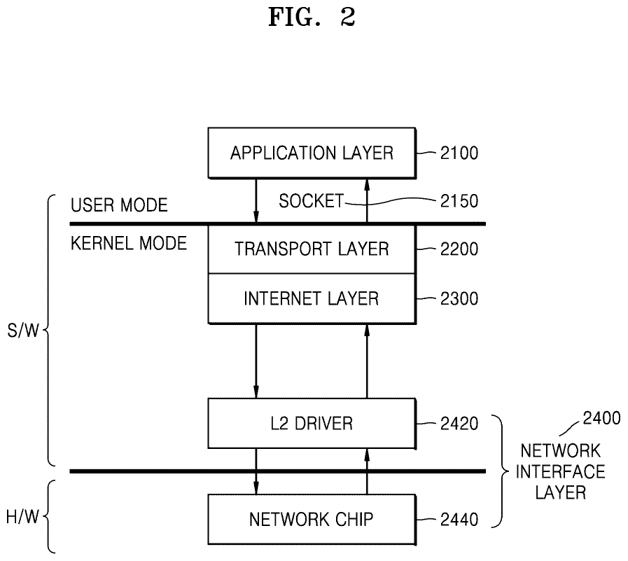

In order to identify the first quantity and the second quantity of packets, the source device 100 according to an embodiment of the disclosure may identify an amount of packets transmitted to each layer in the network stack of the source device 100. The network stack structure and the first quantity and second quantity of packets are described in detail with reference to FIG. 2.

FIG. 2 is a diagram illustrating a network stack structure used in a source device according to an embodiment of the disclosure.

In the disclosure, the “network stack structure” used in a network communication may include one or more layers. The “layer” may refer to a logical structure for dividing a data transceiving process into steps, and each layer may include one or more modules that operate according to a specific protocol and rules.

For example, the network stack structure may include an application layer 2100, a transport layer 2200, an Internet layer 2300, and a network interface layer (or a network access layer) 2400. The network interface layer 2400 may include an L2 driver 2420 and a network chip 2440. The application layer 2100 may be a top layer, and the network interface layer 2400 may be a lowest layer. When the source device 100 according to an embodiment of the disclosure uses a transmission control protocol (TCP)/Internet protocol (IP) network stack, the transport layer 2200 may include a TCP layer, and the Internet layer 2300 may include an IP layer.

In the disclosure, for convenience of explanation, the transport layer 2200, the Internet layer 2300, and the network interface layer 2400 are referred to as a “network stack”, and the network stack may be expressed as a lower layer with respect to the application layer 2100.

The application layer 2100, which is a layer for generating data to be actually transmitted, may include a user application program. In the application layer 2100, the source device 100 may generate packets by adding an application header to the data to be transmitted.

In the application layer 2100, the source device 100 may transmit the packets to the receiver by using a socket 2150 through a network communication via the network stack (e.g., 2200, 2300, and 2400). The socket 2150 may acts as a path (or an interface) for transceiving data between devices. In the application layer 2100, the source device 100 may call a socket system to transmit the packets to the transport layer 2200 that is a lower layer. When the socket system is called, a user mode may be switched to a kernel mode. The calling of the socket system may correspond to generating (or executing) the socket 2150. In the kernel mode, the source device 100 may transmit the packets to the receiver via the network stack (e.g., 2200, 2300, and 2400) through the socket 2150.

In order to perform a TCP communication, the transport layer 2200 may add a TCP header to the packets generated in the application layer 2100 and transport the packets to the Internet layer 2300. The TCP header may include the port address of the transmitter and the port address of the receiver. A payload may include the data generated in the application layer 2100. The transport layer 2200, as a part of the OS, may be executed in the kernel mode. However, the disclosure is not limited thereto, and the transport layer 2200 may include a user datagram protocol (UDP) layer for performing a UDP communication.

In order to perform an IP communication, the Internet layer 2300 may further add an IP header to the packets generated in the transport layer 2200 and transport the packets to the network interface layer 2400. The IP header may include the IP address of the transmitter and the IP address of the receiver. The Internet layer 2300, as a part of the OS, may be executed in the kernel mode.

The network interface layer 2400 may perform software-based transmission processing and physical transmission processing on the packets generated in a higher layer (e.g., the Internet layer 2300). The network interface layer 2400 may include the L2 driver 2420 and a network chip 2440. The L2 driver 2420 may include software for providing an interface between hardware and the OS. For example, the L2 driver 2420 may connect the network chip 2440 that is hardware to a TCP/IP layer (e.g., 2200 and 2300) that is a part of the OS. The L2 driver 2420, as a part of the OS, may be executed in the kernel mode. In the kernel mode, the L2 driver 2420 may access the network chip 2440. The L2 driver 2420 may add a physical address (e.g., a media access control (MAC) address) of the receiver to the header of packets and transmit the packets to the network chip 2440 that is the lowest layer. The network chip 2440 may be hardware to connect to the outside through a network. The network chip 2440 may transmit the packets transmitted from the L2 driver 2420 to the outside. The network chip 2440 may be referred to as a network interface card (NIC) or a wired/wireless communication module. The L2 driver 2420 may correspond to a data link layer or a second layer L2 in the OSI 7-layer. The network chip 2440 may corresponds to a physical layer in the OSI 7-layer.

In one example, the L2 driver 2420 may include a Wi-Fi driver, and the network chip 2440 may include a Wi-Fi chip. In this case, the L2 driver 2420 may convert the data from the TCP/IP layer (e.g., 2200 and 2300) into a form that the Wi-Fi chip can understand, or transmit the data received by the Wi-Fi chip to a higher layer. However, the disclosure is not limited thereto, and the L2 driver 2420 may include an Ethernet driver, and the network chip 2440 may include an Ethernet chip.

In an embodiment of the disclosure, when the source device 100 is connected to the display device 200 in a WFD method, by adding a TCP header, an IP header, and a MAC header to the data generated in the application layer 2100, the data may be transmitted in the form of direct packets to the display device 200 in a WFD method.

For the WFD method, which is different from a Wi-Fi method of connecting devices indirectly through the AP or a plurality of routers, devices may be directly connected to each other. Accordingly, when one packet is transmitted from the network chip 2440 of the network interface layer 2400 to the display device 200, the L2 driver 2420 may deliver one packet down to the network chip 2440, and the Internet layer 2300 may deliver one packet down to the L2 driver 2420. In this case, the display device 200 may receive one packet and store the packet in a buffer. In other words, in the WFD method, a quantity (or a transmission speed) of packets transmitted to the display device 200 through the network chip 2440 of the source device 100 may be the same as at least one of the quantity (or a receiving speed) of packets that the display device 200 receives from the source device 100, the quantity of packets transmitted from the Internet layer 2300 to the L2 driver 2420, or the quantity of packets transmitted from the L2 driver 2420 to the network chip 2440.

Accordingly, the source device 100 may identify the quantity of packets that is received or transmitted by the L2 driver 2420 of the network interface layer 2400, corresponding to the quantity (second quantity) of packets transmitted from the source device 100 to the display device 200. The source device 100 may predict (or estimate) the second quantity of packets directly transmitted from the network chip 2440 to the display device 200, by using the quantity of packets obtained through the L2 driver 2420.

The quantity of packets (first quantity) generates based on media data may be the same as the quantity of packets (first quantity) transmitted from the application layer 2100 to the transport layer 2200 via the socket 2150. Accordingly, the source device 100 may identify the quantity of packets (first quantity) transmitted from the application layer 2100 to the transport layer 2200 via the socket 2150, corresponding to the quantity of packets (first quantity) generated based on the media data.

The source device 100 may adjust the bitrate of media data based on the difference between the first quantity and the second quantity.

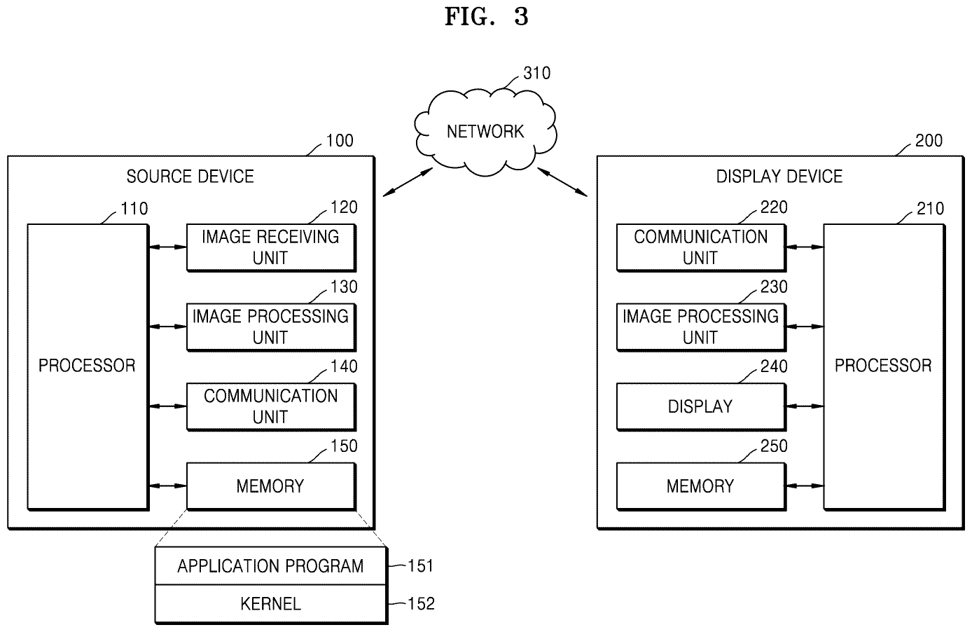

FIG. 3 is a configuration block diagram of the source device 100 and the display device 200 according to an embodiment of the disclosure.

Referring to FIG. 3, the system according to an embodiment of the disclosure may include the source device 100, the display device 200, and a network 310 that connects the source device 100 and the display device 200 to each other.

The network 310 may be a short-range communication network that enables communication between the source device 100 and the display device 200 existing within a short-range, and may include, for example, WFD. For example, the network 310 may be Wi-Fi 7 that enables a wireless communication with an external device through different frequency bands (e.g., a 2.4 GHz band, a 5 GHz band, and a 6 GHz band) and channels, by means of multi-link operation (MLO) technology, but the disclosure is not limited thereto. Examples of the network 310 are not limited thereto, and may use, for example, a wide local area network (WLAN) (or Wi-Fi), Bluetooth, Bluetooth low energy (BLE), soft AP, or near field communication (NFC). The soft AP is an acronym of a software enabled access point and refers to software that enables a computer, not a router, as a wireless access point.

First, the source device 100 is described.

The source device 100 according to an embodiment of the disclosure may include a processor 110, an image receiving unit 120, an image processing unit 130, a communication unit 140, and memory 150. However, not all of the illustrated components are essential components. The source device 100 may be implemented by more components than the components shown, or the source device 100 may be implemented by fewer components.

The image receiving unit 120 may receive an image from an external device. The image receiving unit 120 may include at least one of a tuner unit, a communication unit, or an input/output unit. The tuner unit, under the control of the processor 110, may tune and select only a frequency of a channel to be received by the source device 100 from among a plurality of radio wave components through amplification, mixing, or resonance of broadcast content received by wire or wirelessly. The content received through the tuner unit may be demuxed by the source device 100 into video, audio, and/or added information.

The input/output unit, under the control of the processor 110, may receive, from the external device, a video (e.g., a dynamic image signal, a still image signal, etc.), audio (e.g., a voice signal, a music signal, etc.), and added information. The input/output unit may include at least one of a high-definition multimedia interface (HDMI) port, a component jack, a PC port, or a USB port. In addition, the input/output unit may further include a display port (DP), thunderbolt, or a mobile high-definition link (MHL). The input/output unit may further ports for separate outputs of video and audio.

The communication unit, under the control of the processor 110, may connect the source device 100 to a peripheral device, an external device, a server, or a mobile terminal. The communication unit may receive an image from a content providing server such as a streaming server.

In an embodiment of the disclosure, the image receiving unit 120 may receive an image signal including media data from an external source device. The media data received through the image receiving unit 120 may be packetized into packets that are chunks smaller than the media data and transmitted to the display device 200 through the network 310.

The image processing unit 130 may process audio data and video data included in the image signal received from the image receiving unit 120. The image processing unit 130 may include an audio processing unit for performing various processes, such as demuxing, encoding, and packetizing, on the audio data. The image processing unit 130 may include a video processing unit for performing various processes, such as demuxing, encoding, and packetizing, on the video data. The video processing unit may include media codecs for processing the video data.

The communication unit 140, under the control of the processor 110, may connect the source device 100 to a peripheral device, an external device, a server, or a mobile terminal. The communication unit 140 may include various communication circuitry included in at least one communication module. The communication unit 140 may include a short-range communication module, a wireless Internet module, or a wired Ethernet, corresponding to the performance and structure of the source device 100.

The short-range communication module may include, as a module for a short-range communication, a WLAN module (a Wi-Fi module), a Bluetooth module, a Zigbee module, an infrared data association (IrDA) module, or a WFD module, but the disclosure is not limited thereto. The WLAN module may transceive a Wi-Fi signal with respect to the peripheral device according to the Wi-Fi communication protocols. The Bluetooth module may receive a Bluetooth signal transmitted from the peripheral device according to the Bluetooth communication protocols. The WFD module may support a peer-to-peer (P2P) communication that enables a direct connection between two devices without an AP. The Wi-Fi may use a frequency of a 2.4 GHz band, a 5 GHz band, or a 6 GHz band. The short-range communication module may be used for communication with the display device 200.

The wireless Internet module, as a module for wireless Internet connection, may be built in or provided outside a device. The wireless Internet module may include a WLAN module or a wireless broadband (Wibro) module. The wireless Internet module may be used for the source device 100 to communicate with a server device. The WLAN module may be used as a wireless Internet module when acting as a connection to the Internet through an AP.

The source device 100 according to an embodiment of the disclosure may include a WFD module. The WFD module may be connected to the network 310 to directly transmit packets corresponding to the media data to the display device 200. The WFD module may include a network chip (e.g., 2440 of FIG. 2) implemented by hardware. The network chip may be referred to as a “wireless communication module”.

The processor 110 may be electrically connected to components included in the source device 100 and may execute operations or data processing with respect to control and/or communication of the components included in the source device 100. In an embodiment of the disclosure, the processor 110 may process a request, a command, or data received from at least one of other components by loading the same on memory, and store processing result data in the memory. In an embodiment of the disclosure, the processor 110 may include at least one of a general purpose processor, such as a CPU, an application processor (AP), or a digital signal processor (DSP), a graphics dedicated processor, such as a graphics processing unit (GPU) or a vision processing unit (VPU), or an artificial intelligence dedicated processor such as a neural processing unit (NPU).

The processor 110 may process input data or control other components to process the input data according to data, operation rules, algorithms, methods, or models stored in the memory 150. The processor 110 may execute predefined operation rules, algorithms, methods, or models stored in the memory 150 by using the input data.

The memory 150 may be electrically connected to the processor 110 and may store one or more modules, algorithms, operation rules, models, programs, instructions, or data related to the operations of the components included in the source device 100. For example, the memory 150 may store one or more modules, algorithms, operation rules, models, programs, instructions, or data for the processing and control of the processor 110. The memory 150 may include at least one type of storage media of a flash memory type memory, a hard disk type memory, a multimedia card micro type memory, or a card type memory (e.g., an SD or XD memory, etc.), random access memory (RAM), static random access memory (SRAM), read-only memory (ROM), electrically erasable programmable ROM (EEPROM), programmable ROM (PROM), a magnetic memory, a magnetic disk, or an optical disc, but the disclosure is not limited thereto.

The memory 150 may include an application program 151 and a kernel 152. At least a part of the kernel 152 may be referred to as the OS.

The application program 151 according to an embodiment of the disclosure may be executed in the user mode. The application program 151 may enter the kernel mode through a system call provided by the kernel 152 to access the hardware resources. For example, an example of the system call may include a socket system call.

The kernel 152 according to an embodiment of the disclosure may control or manage, for example, hardware resources (e.g., the processor 110, the communication unit 140, the memory 150, etc.) used to execute operations or functions implemented in other programs (e.g., the application program 151). The kernel 152 may include software that is loaded in memory (e.g., RAM) and executed, when the OS boots. The kernel 152 may be executed in the kernel mode.

The kernel 152 according to an embodiment of the disclosure may include a transport layer (e.g., 2200 of FIG. 2), an Internet layer (e.g., 2300 of FIG. 2), and an L2 driver (e.g., 2420 of FIG. 2) which are included in the network stack. The transport layer, the Internet layer, and the L2 driver may operate, as a part of the OS, in the kernel mode. The kernel 152 may support the application program 151 to communicate with a network chip (e.g., 2440 of FIG. 2) included in the communication unit 140.

The processor 110 according to an embodiment of the disclosure may obtain, by executing the one or more instructions stored in the memory 150, media packets corresponding to the media data through the image receiving unit 120 and the image processing unit 130.

The processor 110 according to an embodiment of the disclosure may transmit, by executing the one or more instructions stored in the memory 150, the media packets to the display device 200 via the communication unit 140.

The processor 110 according to an embodiment of the disclosure may identify, by executing the one or more instructions stored in the memory 150, the first quantity of media packets generated to transmit the media data to the display device 200.

The processor 110 according to an embodiment of the disclosure may identify, by executing the one or more instructions stored in the memory 150, the second quantity of media packets that a network interface layer (e.g., 2400 of FIG. 2) receives or transports, corresponding to the quantity (e.g., number) of media packets transmitted from the source device 100 to the display device 200 through the network chip.

The processor 110 according to an embodiment of the disclosure may adjust, by executing the one or more instructions stored in the memory 150, the bitrate of media data based on the difference between the first quantity and the second quantity.

Next, the display device 200 is described.

The display device 200 according to an embodiment of the disclosure may include a processor 210, a communication unit 220, an image processing unit 230, a display 240, and memory 250. However, not all of the illustrated components are essential components. The display device 200 may be implemented by more components than the components shown, or the display device 200 may be implemented by fewer components.

The communication unit 220, under the control of the processor 210, may connect the display device 200 to a peripheral device, an external device, a server, or a mobile terminal. The communication unit 220 may include various communication circuitry included in at least one communication module. The communication unit 220 may include a short-range communication module, a wireless Internet module, or wired Ethernet, corresponding to the performance and structure of the display device 200.

The short-range communication module may include, as a module for a short-range communication, a WLAN module (a Wi-Fi module), a Bluetooth module, a Zigbee module, an IrDA module, or a WFD module, but the disclosure is not limited thereto. The WLAN module may transceive a Wi-Fi signal with respect to the peripheral device according to the Wi-Fi communication protocols. The Bluetooth module may receive a Bluetooth signal transmitted from the peripheral device according to the Bluetooth communication protocols. The WFD module may support a P2P communication that enables a direct connection between two devices without an AP. The Wi-Fi may use a frequency of a 2.4 GHz band, a 5 GHz band, or a 6 GHz band.

The wireless Internet module, as a module for wireless Internet connection, may be built in or provided outside a device. The wireless Internet module may include a WLAN module or a Wibro module. The wireless Internet module may be used for the display device 200 to communicate with a server device. The WLAN module may be used as a wireless Internet module when acting as a connection to the Internet through an AP.

The display device 200 according to an embodiment of the disclosure may include a WFD module. The WFD module may be connected to the network 310 to directly receive packets corresponding to the media data from the source device 100. The WFD module may include the network chip (e.g., 2440 of FIG. 2) implemented by hardware.

The image processing unit 230 may process video data to be displayed by the display 240, and perform various image processing operations, such as decoding, rendering, scaling, noise filtering, frame rate conversion, or resolution conversion, on the video data. For example, the image processing unit 230 may include various image processing circuitry. For example, the image processing unit 230 may include media codecs to process image content. Furthermore, the image processing unit 230 may process audio data output by a microphone, thereby performing an operation such as decoding on the audio data.

The display 240 may output, to a screen, content that is received from a broadcasting station or an external device, such as an external server or external storage medium, or is provided by various applications, for example, an OTT service provider or a content provider. The display 240 may content that is received from the source device 100 and image-processed.

The processor 210 may be electrically connected to the components included in the display device 200 and may execute operations or data processing with respect to control and/or communication of the components included in the display device 200. In an embodiment of the disclosure, the processor 210 may process a request, a command, or data received from at least one of other components by loading the same on memory, and store processing result data in the memory. According to embodiments of the disclosure, the processor 210 may include at least one of a general purpose processor, such as a CPU, an AP, or a DSP, a graphics dedicated processor, such as a GPU or a VPU, or an artificial intelligence dedicated processor such as an NPU.

The processor 210 may process input data or control other components to process the input data according to data, operation rules, algorithms, methods, or models stored in the memory 250. The processor 210 may execute predefined operation rules, algorithms, methods, or models stored in the memory 250 by using the input data.

The memory 250 may be electrically connected to the processor 210 and may store one or more modules, algorithms, operation rules, models, programs, instructions, or data related to the operations of the components included in the display device 200. For example, the memory 250 may store one or more modules, algorithms, operation rules, models, programs, instructions, or data for the processing and control of the processor 210. The memory 250 may include at least one type of storage media of a flash memory type memory, a hard disk type memory, a multimedia card micro type memory, or a card type memory (e.g., an SD or XD memory, etc.), RAM, SRAM, ROM, EEPROM, PROM, a magnetic memory, a magnetic disk, or an optical disc, but the disclosure is not limited thereto.

The memory 250, like the memory 150 of the source device 100 described above, may include an application program, a kernel, and a network driver, which are the same as those in the memory 150 and thus descriptions of which are omitted.

The processor 210 according to an embodiment of the disclosure may receive, by executing the one or more instructions stored in the memory 250, media packets from the source device 100.

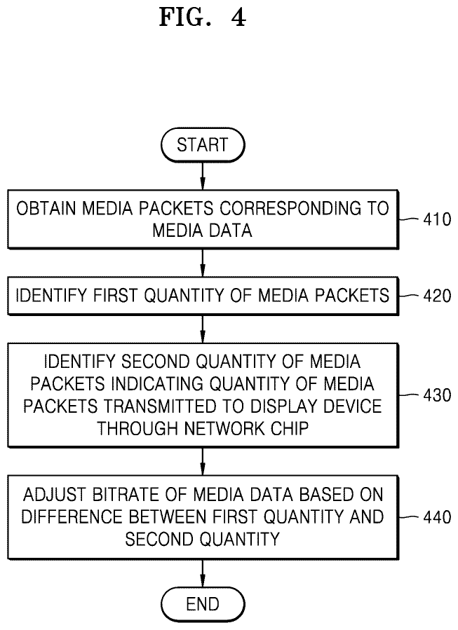

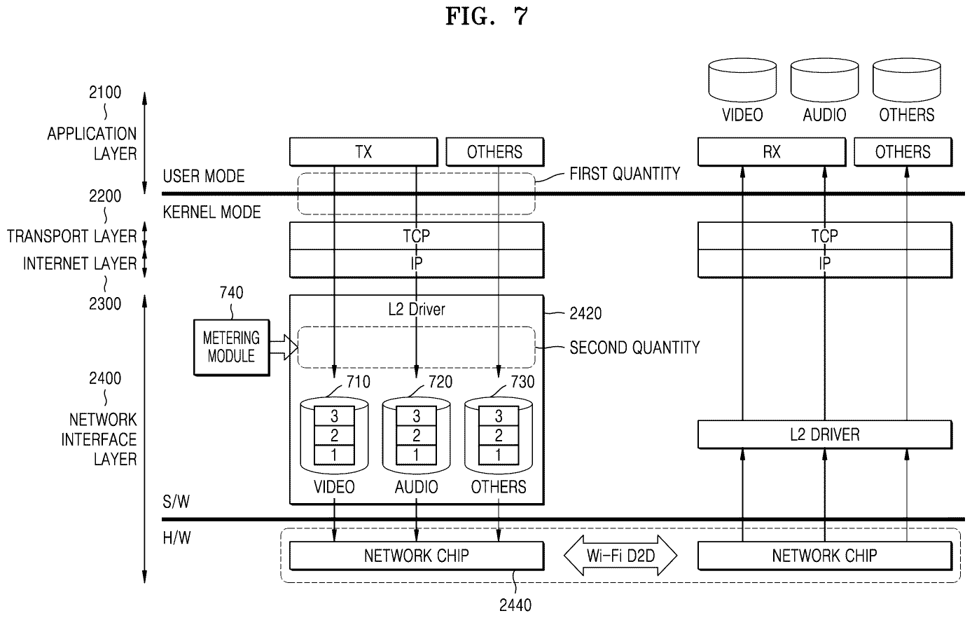

FIG. 4 is a flowchart for describing an operating method of the source device 100, according to an embodiment of the disclosure. The operating method of the source device 100 according to an embodiment of the disclosure may be performed by the processor (110 of FIG. 3) of the source device 100. FIG. 4 is described with reference to the application layer 2100, the transport layer 2200, the Internet layer 2300, and the network interface layer 2400 of FIG. 2 or 7.

Referring to FIG. 4, in operation 410, the source device 100 may obtain media packets based on media data, in the application layer 2100. The application layer 2100 may be a layer for executing a user application program.

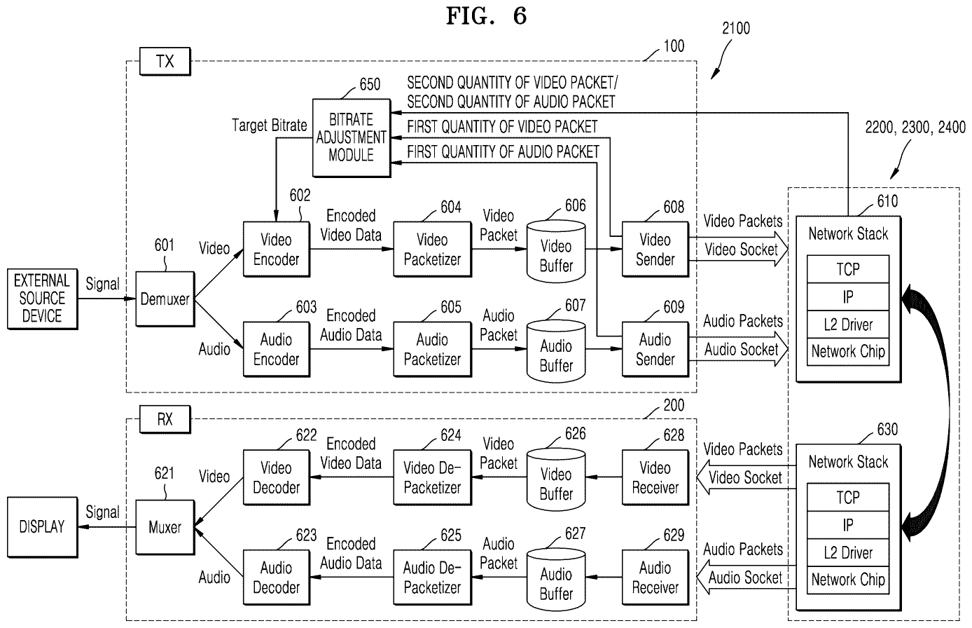

The source device 100 may receive an image signal including media data through the image receiving unit 120. The source device 100 may process the image signal through the image processing unit 130. The source device 100 may divide the media data into packet units that are smaller than the media data and generate one or more media packets. The media data may include video data and audio data corresponding to streaming data. The source device 100 may separate data such as video, audio, or added information included in one transmission stream. The source device 100 may encode data of each of the separated video, audio, and added information. The source device 100 may obtain a video packet, an audio packet, and an added information packet corresponding to the encoded video, audio, and added information, respectively. This is described in detail with reference to FIG. 6.

In operation 420, the source device 100 may identify the first quantity of media packets obtained in the application layer 2100 according to operation 410. The first quantity of media packets may correspond to a quantity (e.g., number) of media packets that are transmitted from the application layer 2100 to the transport layer 2200 that is a lower layer, through a socket.

The source device 100 may transmit the obtained media packets to the network stack (e.g., 2200, 2300, and 2400) though the socket. The socket may act as a path (or an interface) for transceiving data between devices.

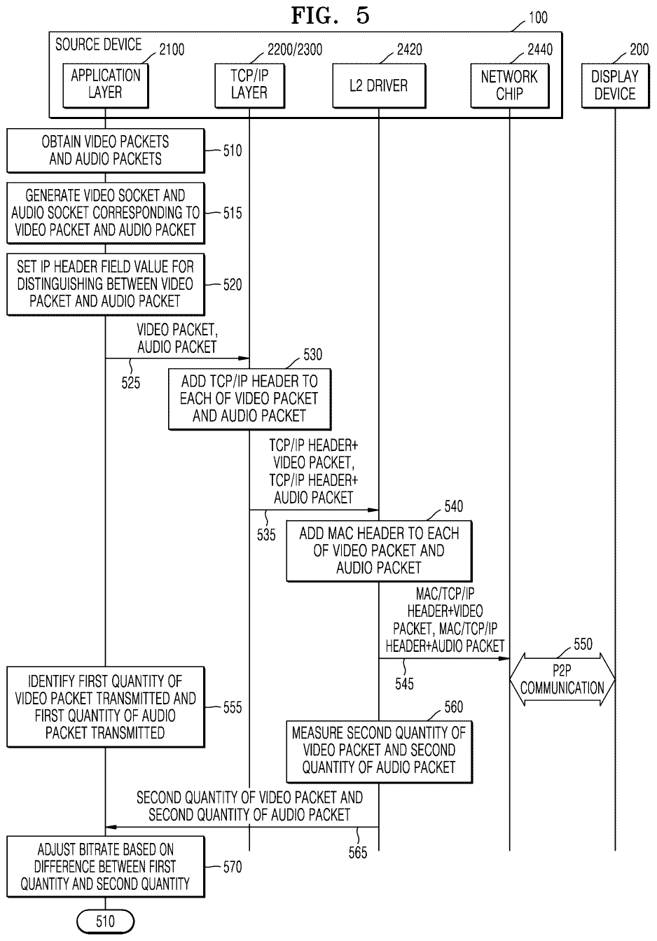

The source device 100 may transmit, by calling a socket system, the packets from the application layer 2100 to the transport layer 2200 that is a lower layer. When the socket system is called, the user mode may be switched to the kernel mode. The source device 100 may transmit, in the kernel mode, the packets to the transport layer 2200 through the socket. For example, the source device 100 may generate (or execute) a TCP socket, and transmit the media packets to the display device 200, through the socket, by passing through the network stack (e.g., 2200, 2300, and 2400). The source device 100 may add a header corresponding to each layer to the media packets while passing through the network stack (e.g., 2200, 2300, and 2400). For example, the source device 100 may add a TCP header in the transport layer 2200, an IP header in the Internet layer 2300, and a MAC header in the network interface layer 2400. The source device 100 may transmit the media packets including the TCP header, the IP header, and the MAC header to the display device 200. A specific media packet transmission process is described in operations 510 to 550 in FIG. 5.

The source device 100 may identify the quantity of media packets (first quantity) transmitted through the socket in the application layer 2100. The quantity of media packets (first quantity) transmitted through the socket may correspond to the quantity (e.g., number) of media packets transmitted from the application layer 2100 to the transport layer 2200 that is a lower layer. The source device 100 may track the amount of data transmitted through the socket in the application layer 2100. For example, the source device 100 may accumulatively record the amount (e.g., byte number) or number of transmitted media packets whenever the media packets are transmitted through the socket. However, the disclosure is not limited thereto.

The quantity of media packets (first quantity) transmitted from the application layer 2100 to the transport layer 2200 of the source device 100 may be identified in real time.

The quantity of the video packet (first quantity) transmitted through a video socket and the quantity of the audio packet (first quantity) transmitted through an audio socket in the application layer 2100 of the source device 100 may each be identified, which is described with reference to FIG. 5.

In operation 430, the source device 100 may identify the second quantity of media packets indicating the quantity (e.g., number) of media packets transmitted to the display device 200 through the network chip 2440. The network chip 2440 may be referred to as a wireless communication module.

In an embodiment of the disclosure, the network interface layer 2400 may include the L2 driver 2420 and the network chip 2440. The second quantity of media packets may correspond to at least one of the quantity (e.g., number) of media packets transmitted from the Internet layer 2300 to the L2 driver 2420, or the quantity (e.g., number) of media packets transmitted from the L2 driver 2420 to the network chip 2440.

In an embodiment of the disclosure, the source device 100 and the display device 200 may be connected to each other by the WFD method. As described with reference to FIG. 2, for the WFD method, which is different from the Wi-Fi method of connecting devices indirectly through the AP or a plurality of routers, devices may be directly connected to each other. Accordingly, when one packet is transmitted from the network chip 2440 of the network interface layer 2400 to the display device 200, the L2 driver 2420 may deliver one packet down to the network chip 2440, and the Internet layer 2300 may deliver one packet down to the L2 driver 2420 In this case, the display device 200 may receive one packet and store the packet in a buffer. In other words, in the WFD method, a quantity of packets transmitted to the display device 200 through the network chip 2440 of the source device 100 may be the same as at least one of the quantity of packets that the display device 200 receives from the source device 100, the quantity of packets transmitted from the Internet layer 2300 to the L2 driver 2420, or the quantity of packets transmitted from the L2 driver 2420 to the network chip 2440.

The source device 100 may measure the quantity (e.g., number) of media packets transmitted from the Internet layer 2300 to the L2 driver 2420, corresponding to the second quantity of media packets. The L2 driver 2420 may include a metering module (see 740 of FIG. 7) for measuring a packet receiving rate or a packet transmission rate in the L2 driver 2420. For example, the source device 100 may measure the quantity (e.g., number) of packets transmitted from the Internet layer 2300 to the L2 driver 2420 through the metering module. However, the disclosure is not limited thereto, and the source device 100 may measure the quantity (e.g., number) of packets transmitted from the L2 driver 2420 to the network chip 2440 through the metering module. The L2 driver 2420 may transmit the second quantity of media packets obtained through the metering module to the application layer 2100.

The source device 100 may predict (or estimate) the second quantity of packets directly transmitted from the network chip 2440 to the display device 200 by using the quantity (e.g., number) of packets obtained through the L2 driver 2420.

Accordingly, the source device 100 may predict the buffer state (or buffering) of the display device 200 by predicting the second quantity of media packets transmitted from the source device 100 to the display device 200.

In operation 440, the source device 100 may adjust the bitrate of media data based on the difference between the first quantity and the second quantity.

The source device 100 may predict the buffering state of the display device 200 based on the difference between the quantity of media packets (first quantity) that the source device 100 has transmitted through the socket and the quantity of packets (second quantity) transmitted to the display device 200.

For example, the first quantity corresponding to the quantity (e.g., number) of packets that the source device 100 has prepared for transmitting data and the quantity (e.g., number) of packets that are actually transmitted to the display device 200 may be different from each other. The difference between the first quantity and the second quantity may be generated when the network state between the source device 100 and the display device 200 is unstable or in the CPU overload state.

For example, in the inter-device direct connection method, when the difference between the first quantity and the second quantity is relatively large, the quantity of packets actually transmitted to the receiver is less than the quantity of packets prepared by the transmitter to transmit, it may be a state in which data is insufficient in the buffer of the receiver. Accordingly, the source device 100 may predict the quantity of packets (e.g., 20 units) that have been less transmitted to the display device 200 based on the difference between the first quantity (e.g., 100 units) and the second quantity (e.g., 80 units). In other words, a quantity corresponding to the remained size of the buffer of the display device 200 may be 20 units.

The source device 100 may decrease, increase, or maintain the bitrate of media data based on the difference between the first quantity and the second quantity. The adjustment of the bitrate of media data may be performed by an encoder in the source device 100.

When the difference between the first quantity and the second quantity is a threshold value or more, the source device 100 may adjust the bitrate of media data to be reduced. For example, when the difference between the first quantity and the second quantity is 20% (i.e., 20 units) with respect to the first quantity, the source device 100 may adjust the bitrate of media data to be reduced by 30%. The source device 100 may encode (compress) the media data by lowering a basic bitrate set to 60 Mbps to 42 Mbps. In this case, an image configured with 60 frames per second signal may be compressed to 0.7 Mbps, not 1 Mbps per one frame.

When the difference between the first quantity and the second quantity is less than the threshold value, the source device 100 may adjust the bitrate of media data to increase.

Alternatively, the source device 100 may divide the difference between the first quantity and the second quantity into three sections, and decrease the bitrate of media data when the difference is greater or equal to a first threshold value, increase the bitrate when the difference is less than a second threshold value that is less than the first threshold value, and maintain the bitrate to be unchanged when the difference is between the first threshold value and the second threshold value.

The source device 100 may determine at least one of whether to adjust a bitrate or an amount of the bitrate adjustment according to the difference between the first quantity and the second quantity. For example, the source device 100 may increase bitrate decrease amount or increase amount as the difference between the first quantity and the second quantity increases. The source device 100 may change the originally set first bitrate to a second bitrate that is lower than the first bitrate when the difference between the first quantity and the second quantity is relatively large, and change the first bitrate back to a third bitrate (or first bitrate) that is greater than the second bitrate when the difference is relatively small.

The source device 100 may obtain media data that is compressed based on the adjusted bitrate. The source device 100 may generate media packets based on the compressed media data and transmit the media packets to the display device 200 though the network stack (e.g., 2200, 2300, and 2400) according to the operation described above.

Accordingly, in the inter-device direct connection method using the WFD method, the source device 100 that is the transmitter may predict whether packets are appropriately transmitted to the display device 200 that is the receiver, by identifying the quantity of packets (first quantity) transmitted from the application layer 2100 to the network stack (e.g., 2200, 2300, and 2400) through the socket and the quantity of packets (second quantity) measured in the network interface layer 2400. In other words, the source device 100 may identify the remained size of the buffer of the display device 200, in real time, without receiving separate feedback from the display device 200. The source device 100 may adjust the bitrate by predicting the buffering state of the display device 200. The source device 100 may prevent the buffer under-run of the display device 200 and provide a user with an image with continuity.

In the disclosure, the quantity is described as a number, but the disclosure is not limited thereto, and the quantity may include at least one of capacity or number.

In an embodiment of the disclosure, when the adjustment ratio of the bitrate of media data (e.g., 30%) is greater than a difference ratio (i.e., a difference with respect to the first quantity) (e.g., 20%) between the first quantity and the second quantity, the buffer under-run problem may be quickly addressed. However, an amount of the bitrate adjustment according to the quantity of packets is merely an example, and the disclosure is not limited to a specific number.

In an embodiment of the disclosure, in order to adjust the bitrate of an image, the source device 100 may identify image resolution information or data compression ratio information corresponding to the adjusted bitrate, and adjust the resolution or data compression ratio of an image according to the identified resolution information or data compression ratio information. For example, in order to reduce the bitrate of an image, the source device 100 may reduce the resolution of an image by using the resolution information of an image corresponding to the reduced bitrate. For example, in order to reduce the bitrate of an image, the source device 100 may increase the data compression ratio of an image by using the data compression ratio information corresponding to the reduced bitrate. Reversely, in order to increase the bitrate of an image, the source device 100 may increase the resolution of an image. Alternatively, in order to increase the bitrate of an image, the source device 100 may reduce the data compression ratio of an image.

In an embodiment of the disclosure, the source device 100 may include a video encoder and an audio encoder respectively for the video data and the audio data. The source device 100 may determine whether to adjust the bitrate and determine an amount of the bitrate adjustment for each of the video packet and the audio packet. The source device 100 may adjust the bitrate of the video packet through the video encoder. The source device 100 may adjust the bitrate of the audio packet through the audio encoder. This is described in detail with reference to FIG. 5.

FIG. 5 is a flowchart for describing an operating method in which a source device transmits media data by using a network stack structure, according to an embodiment of the disclosure. The operating method of the source device 100 according to an embodiment of the disclosure may be performed by the processor (110 of FIG. 3) of the source device 100. Operations 510 to 550 describe a packet transmission method, and operations 555 to 570 describe an adaptive bitrate streaming method. Operations 510 to 550 and operations 555 to 570 may be independently performed without being sequentially performed.

Referring to FIG. 5, in operation 510, the source device 100 may obtain a video packet and an audio packet based on media data in the application layer 2100. The source device 100 may separate data such as video, audio, or added information included in one transmission stream. The source device 100 may obtain a video packet, an audio packet, and an added information packet corresponding to the data such as video, audio, and added information, respectively.

For example, a demuxer 601 of FIG. 6 may separate video data and audio data from image signals received from an external source device. A video encoder 602 of FIG. 6 may receive video data from the demuxer 601 and obtain encoded video data. A video packetizer 604 of FIG. 6 may receive the encoded video data and convert the data in the form of packets suitable for network transmission so as to generate a video packet. The video packetizer 604 may store the generated video packet in a video buffer 606 of FIG. 6 or transfer the packets to a video sender 608 of FIG. 6.

For example, an audio encoder 603 of FIG. 6 may receive audio data from the demuxer 601 and obtain encoded audio data. An audio packetizer 605 of FIG. 6 may receive the encoded audio data and convert the data in the form of packets suitable for network transmission so as to generate an audio packet. The audio packetizer 605 may store the generated audio packet in an audio buffer 607 of FIG. 6 or transfer the packets to an audio sender 609 of FIG. 6.

In operation 515, the source device 100 may generate (or execute) a video socket and an audio socket corresponding to the video packet and the audio packet, respectively, by calling a socket system in the application layer 2100. The video socket may serve as paths for transmitting the video packet between devices. The audio socket may serve as paths for transmitting the audio packet between devices. A network communication path for transceiving each of the video packet and the audio packet may be established between the source device 100 and the display device 200. When the socket system is called, the user mode may be switched to the kernel mode.

In operation 520, the source device 100 may set IP header field value for distinguishing between the video packet and the audio packet in each of the video packet and the audio packet to be transmitted. In operation 525, the source device 100 may transmit the video packet and the audio packet to the TCP/IP layers 2200 and 2300 through the video socket and the audio socket. For example, the video sender 608 of FIG. 6 may set the IP header field value and transmit the video packet to the TCP/IP layers 2200 and 2300 through the video socket. The audio sender 609 of FIG. 6 may set the IP header field value and transmit the audio packet to the TCP/IP layers 2200 and 2300 through the audio socket.

For example, the field value may include information about a differentiated service code point (DSCP) field. The DSCP field may be information included in the IP header of the Internet layer 2300. The DSCP field may be information for managing the quality of services (QOS) of network traffic. For example, the source device 100 may set the DSCP field to 0x2c in hexadecimal for the video packet, and the DSCP field to 0x3c for the audio packet. However, the disclosure is not limited thereto. 0x3c may have a higher traffic priority than 0x2c. For example, the video sender 608 of FIG. 6, when transmitting the video packet through the video socket, may set the DSCP field value together. The audio sender 609 of FIG. 6, when transmitting the audio packet through the audio socket, may set the DSCP field value together. The video packet and the audio packet, each including an IP header having a different field value, may be separately stored in a video buffer (710 of FIG. 7) and an audio buffer (720 of FIG. 7) of the L2 driver 2420 to be described below. In other words, the DSCP field may be used to store the media data in the L2 driver 2420 to be separated by type (video, audio, added information, etc.).

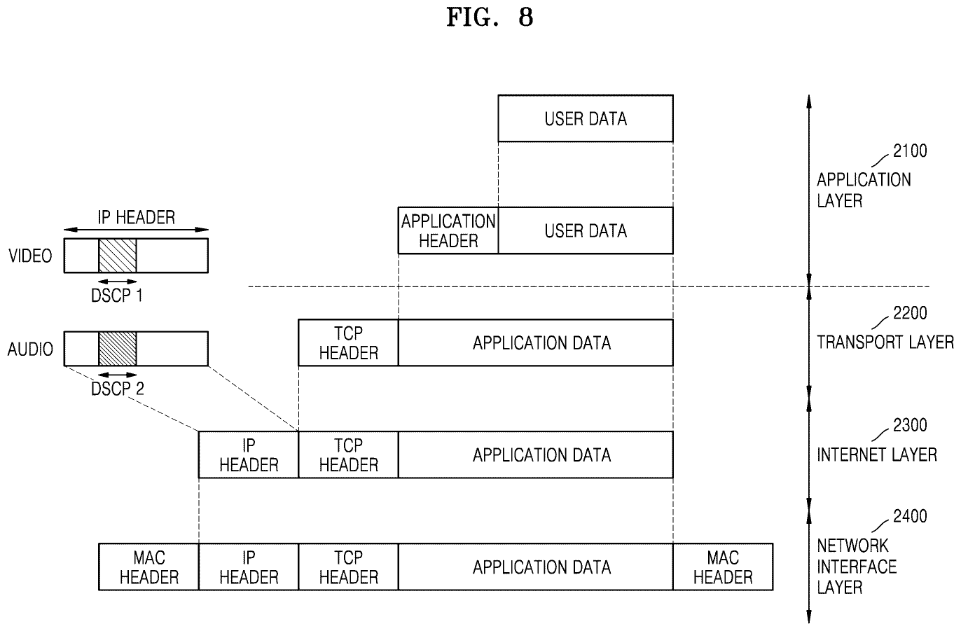

In operation 530, the source device 100 may add the TCP header and the IP header to each of the video packet and the audio packet in the TCP/IP layers 2200 and 2300. The TCP layer may add a TCP header to the packets received from the application layer 2100 and transmit the packets to the IP layer. The IP layer may add an IP header to the packets received from the TCP layer. The IP header may include a DSCP field value for distinguishing between the video packet and the audio packet set in operation 520. The IP headers having different DSCP field values are illustrated in FIG. 8.

In operation 535, the source device 100 may transmit, to the L2 driver 2420, each of the video packet to which the TCP/IP headers have been added and the audio packet to which the TCP/IP headers have been added.

In operation 540, the source device 100 may add a MAC header to each of the video packet and the audio packet through the L2 driver 2420. The L2 driver 2420 may include the video buffer (710 of FIG. 7) for storing the video packet, the audio buffer (720 of FIG. 7) for storing the audio packet, and an added information buffer (730 of FIG. 7) for storing the added information. The L2 driver 2420 may separately store the video packet and the audio packet in the respective buffers based on the different DSCP field values added to the IP headers. For example, the L2 driver 2420 may store the video packet in the video buffer (710 of FIG. 7) and the audio packet in the audio buffer (720 of FIG. 7). Furthermore, the L2 driver 2420 may store the added information in the added information buffer (730 of FIG. 7).

In operation 545, the source device 100 may transmit, to the network chip 2440, the video packet to which the MAC/TCP/IP headers have been added and the audio packet to which the MAC/TCP/IP headers have been added through the L2 driver 2420.

In operation 550, the source device 100 may perform a P2P communication with the display device 200 through the network chip 2440. For example, the source device 100 may be connected to the display device 200 by the WFD method. However, the disclosure is not limited thereto. The display device 200 may receive the video packet from the source device 100 through the network communication path for the video packet established in operation 515. The display device 200 may receive the audio packet from the source device 100 through the network communication path for the audio packet established in operation 515.

In operation 555, the source device 100 may identify the first quantity of the video packet transmitted through the video socket. The source device 100 may identify the first quantity of the audio packet transmitted through the audio socket. The source device 100 may identify a first quantity of the video packet and a first quantity of the audio packet separately. Each of the first quantity of the video packet and the first quantity of the audio packet may be identified and transmitted in real time. For example, the video sender 608 of FIG. 6 may identify the first quantity of the video packet transmitted through the video socket. The video sender 608 may transmit the first quantity of the video packet to a bitrate adjustment module 650 of FIG. 6. The audio sender 609 of FIG. 6 may identify the first quantity of the audio packet transmitted through the audio socket. The audio sender 609 may transmit the first quantity of the audio packet to the bitrate adjustment module 650 of FIG. 6.

In operation 560, the source device 100 may identify the second quantity of the video packet through the L2 driver 2420. The source device 100 may identify the second quantity of the audio packet through the L2 driver 2420. As described in operation 540, the L2 driver 2420 may separately store the video packet and the audio packet in the respective buffers, based on the different DSCP field values added to the IP headers. For example, the video packet may be stored in the video buffer (710 of FIG. 7) of the L2 driver 2420, and the audio packet may be stored in the audio buffer (720 of FIG. 7) of the L2 driver 2420. The L2 driver 2420 may measure the second quantity of the video packet transmitted from the TCP/IP layers 2200 and 2300 to the video buffer (710 of FIG. 7) by using a metering module (740 of FIG. 7). The L2 driver 2420 may measure the second quantity of the audio packet transmitted from the TCP/IP layers 2200 and 2300 to the audio buffer (720 of FIG. 7) by using the metering module (740 of FIG. 7).

In operation 565, the L2 driver 2420 of the source device 100 may transmit the second quantity of the video packet and the second quantity of the audio packet to the application layer 2100. The source device 100 may identify (or obtain) the second quantity of the video packet and the second quantity of the audio packet in the application layer 2100. Data may be transceived between the L2 driver 2420 and the application layer 2100 through inter-process communication (IPC). Each of the second quantity of the video packet and the second quantity of the audio packet may be measured and transmitted in real time. For example, the L2 driver 2420 may transmit the second quantity of the video packet to the bitrate adjustment module 650 of FIG. 6. The L2 driver 2420 may transmit the second quantity of the audio packet to the bitrate adjustment module 650 of FIG. 6.

In operation 570, the source device 100 may adjust the bitrate in the application layer 2100 based on the difference between the first quantity and the second quantity. The source device 100 may adjust the bitrate of video data based on the difference between the first quantity of the video packet and the second quantity of the video packet. The source device 100 may reconstruct a video packet based on the video data compressed corresponding to the adjusted bitrate. The source device 100 may adjust the bitrate of the audio data based on the difference between the first quantity of the audio packet and the second quantity of the audio packet. The source device 100 may reconstruct an audio packet based on the audio data compressed corresponding to the adjusted bitrate. In other words, the source device 100 may adjust the bitrate and operate again according to operation 510.

For example, the bitrate adjustment module 650 of FIG. 6 may determine whether to adjust the bitrate of the video data and determine an amount of the bitrate adjustment (or an adjusted bitrate value), based on the difference between the first quantity of the video packet and the second quantity of the video packet. The bitrate adjustment module 650 may transit the adjusted bitrate value to the video encoder 602 of FIG. 6. The video encoder 602 may compress the video data corresponding to the adjusted bitrate value. The video encoder 602 may extract the video data compressed corresponding to the adjusted bitrate value. The extracted video data may be reconstructed as a video packet. For example, the video encoder 602 may compress the video data based on at least one of the resolution of an image or the data compression ratio of an image corresponding to the adjusted bitrate value.

For example, the bitrate adjustment module 650 of FIG. 6 may determine whether to adjust the bitrate of the audio data and determine an amount of the bitrate adjustment (or an adjusted bitrate value), based on the difference between the first quantity of the audio packet and the second quantity of the audio packet. The bitrate adjustment module 650 may transmit the adjusted bitrate value to the audio encoder 603 of FIG. 6. The audio encoder 603 may compress the audio data corresponding to the adjusted bitrate value. The audio encoder 603 may extract the compressed audio data corresponding to the adjusted bitrate value. The extracted audio data may be reconstructed as an audio packet.

FIG. 6 is a diagram illustrating an operation of transceiving media data between the source device 100 and the display device 200 via a network, according to an embodiment of the disclosure. FIG. 6 illustrates the application layer 2100 in detail. In FIG. 6, the network stack (e.g., 2200, 2300, and 2400) is briefly illustrated and will be further described with reference to FIG. 7.

Referring to FIG. 6, the source device 100 may include an image processing unit (e.g., 130 of FIG. 3) executed in the application layer 2100. The image processing unit may include appropriate programs, logic, circuitry, interfaces, and/or code for packet processing by separating data such as video, audio, or added information from one transmission stream. For example, the image processing unit may include the demuxer 601, the video encoder 602, the audio encoder 603, the video packetizer 604, the audio packetizer 605, the video buffer 606, the audio buffer 607, the video sender 608, and the audio sender 609.

The demuxer 601 may include appropriate programs, logic, circuitry, interfaces, and/or code for separating data such as video, audio, or added information included in one transmission stream. For example, when the source device 100 receives image signals from an external source device through an HDMI input port, the demuxer 601 may parse data standardized according to the HDMI standards to extract data such as video, audio, or added information.

The video encoder 602 may include appropriate programs, logic, circuitry, interfaces, and/or code for encoding (compressing) raw video data into a specific format. For example, the video encoder 602 may encode video data by using codecs such as H.264 or H.265, but the disclosure is not limited thereto. For example, the video encoder 602 may receive the extracted video data from the demuxer 601 and extract encoded video data.

The video packetizer 604 may include appropriate programs, logic, circuitry, interfaces, and/or code for converting the encoded video data into the form of packets suitable for network transmission. For example, the video packetizer 604 may prepare for dividing an encoded video stream into packets each having a certain size and transmitting the packets through a network. The video packet extracted by the video packetizer 604 may include a payload containing at least part of the encoded video stream and an application header. For example, the structure of the video packet is illustrated in FIG. 8.

The video buffer 606 may be a buffer that temporarily stores the video data before the data is transmitted over the network. The video buffer 606 may include at least one of a queue corresponding to a storage structure of first-in-first-out (FIFO) or a stack corresponding to a storage structure of last-in-first-out (LIFO). For example, the video buffer 606 may store the video packet extracted by the video packetizer 604.

The video sender 608 may generate a socket for a network communication and include appropriate programs, logic, circuitry, interfaces, and/or code for sending the video data through the socket. For example, the video sender 608 may generate a video socket to establish a network communication path for transceiving the video packet between the source device 100 and the display device 200. The video sender 608 may send, through the video socket, the video packet received through the video packetizer 604 or the video buffer 606 to a network stack 610 that is a lower layer. The video packet to which the headers of communication protocols are added by passing through the network stack 610 and which arrives at the network chip that is a lowermost layer may be sent to the display device 200 via the network chip. The network stack 610 is described in detail with reference to FIG. 7.

The audio encoder 603, the audio packetizer 605, the audio buffer 607, and the audio sender 609 are different from the video encoder 602, the video packetizer 604, the video buffer 606, and the video sender 608 described above in that, instead of generating the video packet from the video data and transmitting the same, the audio packet is generated from the audio data and transmitted. The description thereof is omitted.

The display device 200 may include an image processing unit (e.g., 230 of FIG. 3) executed in the application layer 2100. The image processing unit may include appropriate programs, logic, circuitry, interfaces, and/or code for processing the video packet and the audio packet received from the source device 100 to generate image signal and output the signals to the display 200. For example, the image processing unit may include a muxer 621, a video decoder 622, audio decoder 623, a video de-packetizer 624, an audio de-packetizer 625, a video buffer 626, an audio buffer 627, a video receiver 628, and an audio receiver 629. Each component may operate reversely corresponding to the components provided in the image processing unit of the source device 100.

For example, the display device 200 may receive the video packet from the source device 100 through a network stack 630. The display device 200 may transmit the video packet received through the network stack 630 to the application layer 2100 through the video socket. The video receiver 628 may receive the video packet from the network stack 630 through the video socket. The video receiver 628 may transmit the received video packet to the video de-packetizer 624 or the video buffer 626. The video buffer 626 may be a buffer that temporarily stores the received video data. The video de-packetizer 624 may reconstruct the video data received through the network and packetized to the original stream form. The video decoder 622 may reconstruct the compressed video data to the original frame. The muxer 621 may combine multiple data streams (e.g., video, audio, subtitles, etc.) into one incorporated stream. The image signals generated by the muxer 621 may be transmitted to the display 200 through additional rendering or the like.

The audio receiver 629, the audio buffer 627, the audio de-packetizer 625, and the audio decoder 623 are different from the video receiver 628, the video buffer 626, the video de-packetizer 624, and the video decoder 622 described above in that audio data is extracted from the audio packet. The description thereof is omitted. The muxer 621 may combine the video data received from the video decoder 622 and the audio data received from the audio decoder 623 into one incorporated stream.

The source device 100 may further include the bitrate adjustment module 650. The bitrate adjustment module 650 may include appropriate programs, logic, circuitry, interfaces, and/or code for adjusting, by the source device 100, the bitrate of the video data or the audio data. For example, the video sender 608 may identify the first quantity of the video packet transmitted through the video socket and transmit the same to the bitrate adjustment module 650. The network stack 610 may measure the second quantity of the video packet transmitted within the network stack 610 and transmit the same to the bitrate adjustment module 650. The bitrate adjustment module 650 may receive the first quantity of the video packet and the second quantity of the video packet. The bitrate adjustment module 650 may determine whether to adjust the bitrate of the video data and determine an amount of the bitrate adjustment (or the adjusted bitrate value), based on the first quantity of the video packet and the second quantity of the video packet. The bitrate adjustment module 650 may transmit an adjusted bitrate to the video encoder 602.

For example, the audio sender 609 may identify the first quantity of the audio packet transmitted through the audio socket and transmit the same to the bitrate adjustment module 650. The network stack 610 may measure the second quantity of the audio packet transmitted within the network stack 610 and transmit the same to the bitrate adjustment module 650. The bitrate adjustment module 650 may receive the first quantity of the audio packet and the second quantity of the audio packet. The bitrate adjustment module 650 may determine whether to adjust the bitrate of the audio data and determine an amount of the bitrate adjustment (or the adjusted bitrate value), based on the first quantity of the audio packet and the second quantity of the audio packet. The bitrate adjustment module 650 may transmit an adjusted bitrate to the audio encoder 603.

The bitrate adjustment module 650 may periodically receive first quantity information and second quantity information.

The video encoder 602 may compress the video data to have the adjusted bitrate and extract the compressed video data. The extracted video data may be reconstructed as a video packet through the video packetizer 604.

The audio encoder 603 may compress the audio data to have the adjusted bitrate and extract the compressed audio data. The extracted audio data may be reconstructed as an audio packet through the audio packetizer 605.

The first quantity and the second quantity of packets are described in detail with reference to FIGS. 7 and 8.

FIG. 7 is a diagram illustrating an operation of a source device and a display device in a network stack structure, according to an embodiment of the disclosure. FIG. 8 is a diagram illustrating a shape of a packet corresponding to the network stack structure, according to an embodiment of the disclosure. FIG. 7 illustrates in detail the transport layer 2200, the Internet layer 2300, and the network interface layer 2400 that are lower layers of the application layer 2100. The network stack of a transmitter may correspond to the network stack 610 of FIG. 6, and the network stack of a receiver may correspond to the network stack 630 of FIG. 6. The packets illustrated in FIG. 8 may correspond to at least one of the video packet or the audio packet. Any redundant description between FIGS. 2 and 8 are omitted or presented briefly.

The application layer 2100, as described with reference to FIG. 6, may include the demuxer 601, the video encoder 602, the audio encoder 603, the video packetizer 604, the audio packetizer 605, the video buffer 606, the audio buffer 607, the video sender 608, and the audio sender 609. The video sender 608 of the application layer 2100 may generate the video socket and send the video packet to the transport layer 2200 through the video socket. The audio sender 609 may generate the audio socket and send the audio packet to the transport layer 2200 through the audio socket. Referring to FIG. 8, the format of packets transmitted from the application layer 2100 to the transport layer 2200 may include an application header and at least part of stream data (represented as user data).

The transport layer 2200 may add a TCP header to the packet received from the application layer 2100 and transmit the same to the Internet layer 2300. The Internet layer 2300 may add an IP header to the packet received form the transport layer 2200. The Internet layer 2300 may transmit, to the L2 driver 2420, each of the video packet to which the TCP/IP headers have been added and the audio packet to which the TCP/IP headers have been added. Referring to FIG. 8, a value of DSCP 1 may be set in the DSCP field of the IP header of the video packet. A value of DSCP 2 may be set in DSCP field of the IP header of the audio packet. For example, when DSCP 1 is 0x2c and DSCP 2 is 0x3c, in the network traffic, the video packet may have less priority than the audio packet.

The L2 driver 2420 may include the video buffer 710 for storing video packet, the audio buffer 720 for storing audio packet, and the added information buffer 730 for storing added information. The video buffer 710, the audio buffer 720, and the added information buffer 730 may each include at least one storage structure of a queue or a stack. The L2 driver 2420 may separately store the video packet and the audio packet in separate buffers, based on the different DSCP field values added to the IP headers. For example, the L2 driver 2420 may store the video packet in the video buffer 710 and the audio packet in the audio buffer 720. Furthermore, the L2 driver 2420 may store the added information in the added information buffer 730. When the video packet and the audio packet are separately stored by using different DCSP field values, the video packet and the audio packet may each be independently managed. In other words, a video packet problem does not affect the audio packet, and the same applied to the opposite case.

The L2 driver 2420 may include the metering module 740. The metering module 740 may include appropriate logic, circuitry, interfaces, and/or code for measuring a packet receiving rate or a packet transmission rate. The L2 driver 2420 may measure the second quantity of the video packet transmitted from the TCP/IP layers 2200 and 2300 to the video buffer 710 through the metering module 740. The L2 driver 2420 may measure the second quantity of the audio packet transmitted from the TCP/IP layers 2200 and 2300 to the audio buffer 720 through the metering module 740. As the video packet and the audio packet are stored in the separate buffers, the metering module 740 may separately measure the second quantity of the video packet and the second quantity of the audio packet. The L2 driver 2420 may transmit, to the application layer 2100, the second quantity of the video packet and the second quantity of the audio packet measured through the metering module 740.

The video packet and the audio packet arrived at the network chip 2440 may be transmitted to the display device 200 through the network chip 2440. The display device 200 may receive the video packet and the audio packet the network chip provided in the display device 200 and transmit the same to the application layer via the L2 driver, the IP layer, and the TCP layer. The display device 200 may store the video packet, the audio packet, and the added information in the respective buffers (e.g., the video buffer, the audio buffer, and the added information buffer).

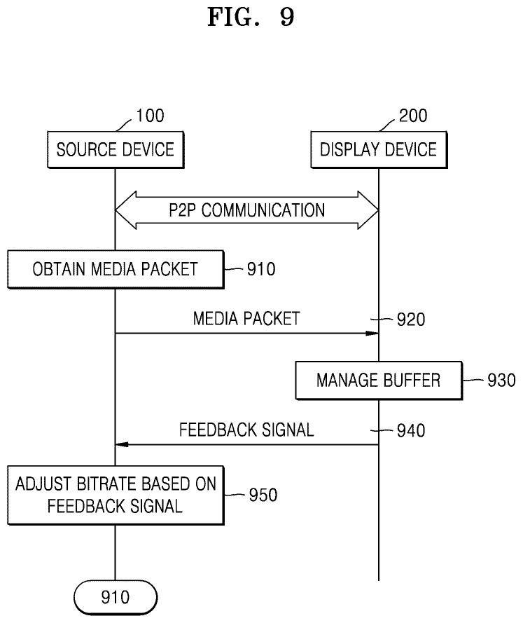

FIG. 9 is a flowchart for describing an operating method of transceiving media data via a network between a source device and a display device, according to an embodiment of the disclosure.

Referring to FIG. 9, the source device 100 is different from the embodiment of the disclosure of FIGS. 4 and 5 described above in that the source device 100 adjusts the bitrate based on a feedback signal received from the display device 200.

In operation 910, the source device 100 may obtain a media packet. The media packet may include a video packet and an audio packet. This corresponds to operation 510 of FIG. 5.

In operation 920, the source device 100 may transmit the media packet to the display device 200. A P2P communication may be performed between the source device 100 and the display device 200. This corresponds to operation 550 of FIG. 5. The display device 200 may receive the media packet from the source device 100.

In operation 930, the display device 200 may manage the buffer in real time. For example, the display device 200 may manage the quantity of the video packet stored in the video buffer (626 of FIG. 6) and the quantity of the audio packet stored in the audio buffer (627 of FIG. 6). When it is determined that the quantity of packets stored in the video buffer (626 of FIG. 6) and the audio buffer (627 of FIG. 6) is insufficient, the display device 200 may generate a feedback signal to be transmitted to the source device 100. The feedback signal may be generated in the application layer of the display device 200.

In operation 940, the display device 200 may generate (or execute) a feedback socket in the application layer and transmit the feedback signal to the network stack (630 of FIG. 6) that is a lower layer, through the feedback socket. The feedback socket may serve as a path for transmitting an inter-device feedback signal. Accordingly, a network communication path for transmitting a feedback signal may be established. The display device 200 may transmit the feedback signal to the source device 100 through the network stack (630 of FIG. 6) The source device 100 may receive the feedback signal from the display device 200 through the established network communication path for transmitting the feedback signal.

In operation 950, the source device 100 may adjust the bitrate of the media data based on the feedback signal. Operation 950 may correspond to 570 of FIG. 5.

When the source device 100 adjusts the bitrate based on the feedback signal received from the display device 200, it is difficult to immediately address the buffer under-run problem in the display device 200. For example, when a network environment between the source device 100 and the display device 200 is unstable, it is difficult for the source device 100 to receive the feedback signal from the display device 200.

Accordingly, as described above in FIGS. 4 and 5, the source device 100 may predict the remained size of the buffer of the display device 200, in real time, without receiving separate feedback from the display device 200.

The source device 100 may operate as illustrated in FIGS. 4 and 5, and concurrently operate according to operations 910 to 940.

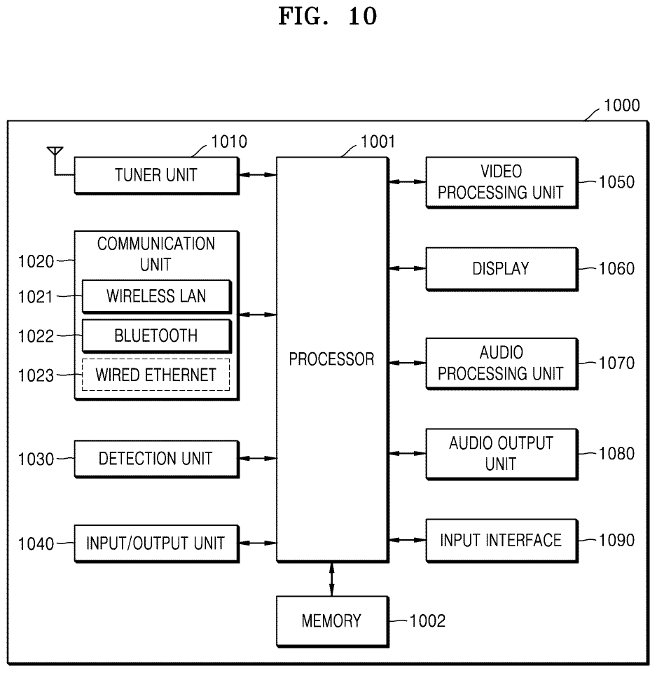

FIG. 10 is a system block diagram of a source device and a display device, according to an embodiment of the disclosure.

Referring to FIG. 10, a system 1000 may include a processor 1001, memory 1002, a tuner unit 1010, a communication unit 1020, a detection unit 1030, an input/output unit 1040, a video processing unit 1050, a display 1060, an audio processing unit 1070, an audio output unit 1080, and an input interface 1090.

The processor 1001, the memory 1002, and the communication unit 1020 included in the system 1000 may correspond to the processor 110, the memory 150, and the communication unit 140 included in the source device 100 of FIG. 3. The tuner unit 1010, at least a part of the communication unit 1020, and the input/output unit 1040 included in the system 1000 may correspond to the image receiving unit 120 included in the source device 100 of FIG. 3. The video processing unit 1050 and the audio processing unit 1070 included in the system 1000 may correspond to the image processing unit 130 included in the source device 100 of FIG. 3.

The processor 1001, the memory 1002, the communication unit 1020, and the display 1060 included in the system 1000 may correspond to the processor 210, the memory 250, the communication unit 140, and the display 240 included in the display device 200 of FIG. 3. The video processing unit 1050 and the audio processing unit 1070 included in the system 1000 may correspond to the image processing unit 230 included in the display device 200 of FIG. 3.

The tuner unit 1010 may tune and select only a frequency of a channel to be received by the system 1000 from among a plurality of radio wave components through amplification, mixing, or resonance of broadcast content received by wire or wirelessly. The content received through the tuner unit 1010 is decoded and separated into audio, video, and/or added information. The separated audio, video, and/or added information may be stored in the memory 1002 under the control of the processor 1001.

The communication unit 1020, under the control of the processor 1001 may connect the system 1000 to a peripheral device, an external device, a server, or a mobile terminal. The communication unit 1020 may include at least one communication module capable of performing a wireless communication. The communication unit 1020 may include at least one of a wireless LAN module 1021, a Bluetooth module 1022, or a wired Ethernet 1023, corresponding to the performance and structure of the system 1000.

The wireless LAN module 1021 may transceive Wi-Fi signals with the peripheral device according to the Wi-Fi communication protocols. The Bluetooth module 1022 may receive Bluetooth signals transmitted from the peripheral device according to the Bluetooth communication protocols.

The detection unit 1030 may detect user's voice, user's image, or user's interaction and include a microphone, a camera unit, a light receiving unit, and a sensing unit.

The input/output unit 1040, under the control of the processor 1001, may receive, from the external device or the like, video (e.g., a dynamic image signal, a still image signal, etc.), audio (e.g., a voice signal, a music signal, etc.), or added information. The input/output unit 1040 may include one of an HDMI port, a component jack, a PC port, and a USB port.

The audio processing unit 1070 may process audio data. The audio processing unit 1070 may perform various processes such as decoding, amplification, or noise filtering on the audio data.

The audio output unit 1080, under the control of the processor 1001, may output audio included in the content received through the tuner unit 1010, audio input through the communication unit 1020 or the input/output unit 1040, or audio stored in the memory 1002. The audio output unit 1080 may include at least one of a speaker, headphones, or a Sony/Philips digital interface (S/PDIF) output terminal.

The input interface 1090 may receive a user's input for controlling the system 1000. The input interface 1090 may include various types of user input devices such as a touch panel for detecting a user's touch, a button for receiving a user's push operation, a wheel for receiving a user's rotation operation, a keyboard, a dome switch, a microphone for voice recognition, or a motion detection sensor for sensing a motion, but the disclosure is not limited thereto.

A source device according to an embodiment of the disclosure includes a wireless communication module that supports a direct communication with display device, at least one processor, and memory including one or more storage media storing one or more instructions.

The at least one processor according to an embodiment of the disclosure individually or collectively executes the one or more instructions to cause the source device to identify a first quantity of media packets generated to transmit media data to the display device.

The at least one processor according to an embodiment of the disclosure individually or collectively executes the one or more instructions to cause the source device to identify a second quantity of the media packets indicating a number of media packets transmitted to the display device through the wireless communication module.

The at least one processor according to an embodiment of the disclosure individually or collectively executes the one or more instructions to cause the source device to adjust the bitrate of the media data based on the difference between the first quantity and the second quantity.

According to an embodiment of the disclosure, the first quantity of the media packets may correspond to a number of media packets transmitted from an application layer to a transport layer through a socket.

According to an embodiment of the disclosure, the second quantity of the media packets may correspond to at least one of a number of the media packets transmitted from an Internet layer to an L2 driver or a number of media packets transmitted from the L2 driver to the wireless communication module.

According to an embodiment of the disclosure, the second quantity of the media packets transmitted from the Internet layer to the L2 driver may indicate a number of the media packets measured through the L2 driver.

The source device according to an embodiment of the disclosure may be connected to the display device through Wi-Fi Direct communication.

The at least one processor according to an embodiment of the disclosure may individually or collectively execute the one or more instructions to cause the source device to adjust the bitrate of media data to decrease when the difference between the first quantity and the second quantity is greater than or equal to a threshold value.

The at least one processor according to an embodiment of the disclosure may individually or collectively execute the one or more instructions to cause the source device to adjust the bitrate of the media data to increase or maintain the bitrate of the media data to be unchanged when the difference between the first quantity and the second quantity is less than the threshold value.

According to an embodiment of the disclosure, at least one of whether to adjust the bitrate or an amount of the bitrate adjustment may be determined according to the difference between the first quantity and the second quantity.

The at least one processor according to an embodiment of the disclosure may individually or collectively execute the one or more instructions to cause the source device to transmit an adjusted bitrate value to an encoder based on the difference between the first quantity and the second quantity.

The at least one processor according to an embodiment of the disclosure may individually or collectively execute the one or more instructions to cause the source device to obtain, through the encoder, encoded media data based on the adjusted bitrate value.

The at least one processor according to an embodiment of the disclosure may individually or collectively execute the one or more instructions to cause the source device to obtain video packet and audio packet in the application layer based on the media data.

The at least one processor according to an embodiment of the disclosure may individually or collectively execute the one or more instructions to cause the source device to set an IP header field value to distinguish between the video packet and the audio packet.

According to an embodiment of the disclosure, each of the video packet and the audio packet including the set IP header field value may be stored in a separate buffer.

The at least one processor according to an embodiment of the disclosure may individually or collectively execute the one or more instructions to cause the source device to identify the first quantity of the video packet and the first quantity of the audio packet separately.

The at least one processor according to an embodiment of the disclosure may individually or collectively execute the one or more instructions to cause the source device to identify the second quantity of the video packet and the second quantity of the audio packet separately.

The at least one processor according to an embodiment of the disclosure may individually or collectively execute the one or more instructions to cause the source device to adjust the bitrate of the video data based on the difference between the first quantity of the video packet and the second quantity of the video packet.

The at least one processor according to an embodiment of the disclosure may individually or collectively execute the one or more instructions to cause the source device to adjust the bitrate of the audio data based on the difference between the first quantity of the audio packet and the second quantity of the audio packet.

An operating method of a source device according to an embodiment of the disclosure include identifying a first quantity of media packets generated to transmit media data to a display device, identifying a second quantity of the media packets indicating a number of the generated media packets transmitted to the display device, the generated media packets transmitted to the display device through a wireless communication module that supports direct communication with the display device, and adjusting the bitrate of the media data based on the difference between the first quantity and the second quantity.

According to an embodiment of the disclosure, the adjusting of the bitrate of the media data based on the difference between the first quantity and the second quantity may include when the difference between the first quantity and the second quantity is greater than or equal to a threshold value, adjusting the bitrate of the media data to decrease, and when the difference between the first quantity and the second quantity is less than the threshold value, adjusting the bitrate of the media data to increase or maintaining the bitrate of the media data to be unchanged.

According to an embodiment of the disclosure, the adjusting of the bitrate of the media data based on the difference between the first quantity and the second quantity may include obtaining an adjusted bitrate value based on the difference between the first quantity and the second quantity and obtaining encoded media data based on the adjusted bitrate value through an encoder.

According to an embodiment of the disclosure, the operating method of the source device may further include obtaining a video packet and an audio packet in the application layer based on the media data, setting an IP header field value to distinguish between the video packet and the audio packet, and storing each of the video packet and the audio packet including the set IP header field value in a separate buffer.

According to an embodiment of the disclosure, each of the video packet and the audio packet including the set IP header field value may be stored in a separate buffer.

The operating method of the source device according to an embodiment of the disclosure may further include identifying a first quantity of the video packet and a first quantity of the audio packet separately, identifying a second quantity of the video packet and a second quantity of the audio packet separately, based on a difference between the first quantity of the video packet and the second quantity of the video packet, adjusting the bitrate of the video data, and based on the difference between the first quantity of the audio packet and the second quantity of the audio packet, adjusting the bitrate of the audio data.

A computer-readable storage medium may be provided in the form of a non-transitory storage medium. The “non-transitory storage medium” may mean that a storage medium is a tangible device, not including a signal (e.g., electromagnetic waves). However, the term does not distinguish a case of semi-permanently storing data in a storage medium from a case of temporarily storing data. In an example, a “non-transitory storage medium” may include a buffer in which data is temporarily stored.

According to an embodiment of the disclosure, the method according to various embodiments of the disclosure may be provided by being included in a computer program product. A computer program product as goods may be dealt between a seller and a buyer. A computer program product may be distributed in the form of a device-readable storage medium (e.g., a compact disc read only memory (CD-ROM)), or distributed directly online between two user devices (e.g., smartphones) (e.g., download or upload) through an application store. For online distribution, at least part of a computer program product (e.g., a downloadable application) may be at least temporarily stored or generated on a device-readable storage medium such as a manufacturer's server, a server of the application store, or a memory of a relay server.

1. A source device comprising:
a wireless communication module that supports direct communication with a display device;
at least one processor; and
memory comprising one or more storage media storing one or more instructions,
wherein the at least one processor individually or collectively executes the one or more instructions to cause the source device to:
identify a first quantity of media packets generated to transmit media data to the display device;
identify a second quantity of the media packets indicating a number of media packets transmitted to the display device through the wireless communication module; and
adjust a bitrate of the media data based on a difference between the first quantity and the second quantity.

2. The source device of claim 1, wherein the first quantity of the media packets corresponds to a number of media packets transmitted from an application layer to a transport layer through a socket.

3. The source device of claim 1, wherein the second quantity of the media packets corresponds to at least one of (i) a number of media packets transmitted from an Internet layer to an L2 driver, or (ii) a number of media packets transmitted from the L2 driver to the wireless communication module.

4. The source device of claim 3, wherein the second quantity of the media packets transmitted from the Internet layer to the L2 driver indicates a number of the media packets measured through the L2 driver.

5. The source device of claim 1, wherein the source device is connected to the display device through Wi-Fi Direct communication.

6. The source device of claim 1, wherein the at least one processor individually or collectively executes the one or more instructions to cause the source device to:
when the difference between the first quantity and the second quantity is greater than or equal to a threshold value, adjust the bitrate of the media data to decrease; and
when the difference between the first quantity and the second quantity is less than the threshold value, adjust the bitrate of the media data to increase or maintain the bitrate of the media data to be unchanged.

7. The source device of claim 6, wherein at least one of (i) whether to adjust the bitrate or (ii) an amount of the bitrate adjustment is determined according to the difference between the first quantity and the second quantity.

8. The source device of claim 1, wherein the at least one processor individually or collectively executes the one or more instructions to cause the source device to:
based on the difference between the first quantity and the second quantity, transmit an adjusted bitrate value to an encoder; and
obtain, through the encoder, encoded media data based on the adjusted bitrate value.

9. The source device of claim 2, wherein the at least one processor individually or collectively executes the one or more instructions to cause the source device to:
obtain a video packet and an audio packet in the application layer based on the media data; and
set an Internet protocol (IP) header field value to distinguish between the video packet and the audio packet,
wherein each of the video packet and the audio packet includes the set IP header field value is stored in a separate buffer.

10. The source device of claim 9, wherein the at least one processor individually or collectively executes the one or more instructions to cause the source device to:
identify a first quantity of the video packet and a first quantity of the audio packet separately;
identify a second quantity of the video packet and a second quantity of the audio packet separately;
based on a difference between the first quantity of the video packet and the second quantity of the video packet, adjust a bitrate of video data; and
based on a difference between the first quantity of the audio packet and the second quantity of the audio packet, adjust a bitrate of audio data.

11. An operating method of a source device, the operating method comprising:
identifying a first quantity of media packets generated to transmit media data to a display device;
identifying a second quantity of media packets indicating a number of the generated media packets transmitted to the display device, the generated media packets transmitted to the display device through a wireless communication module that supports direct communication with the display device; and
adjusting a bitrate of the media data based on a difference between the first quantity and the second quantity.

12. The operating method of claim 11, wherein the first quantity of the media packets corresponds to a number of media packets transmitted from an application layer to a transport layer through a socket.

13. The operating method of claim 11, wherein the second quantity of the media packets corresponds to at least (i) one of a number of media packets transmitted to an L2 driver, or (ii) a number of media packets transmitted from the L2 driver to the wireless communication module.

14. The operating method of claim 13, wherein the second quantity of the media packets transmitted from the Internet layer to the L2 driver indicates a number of media packets measured through the L2 driver.

15. The operating method of claim 11, wherein the source device is connected to the display device through Wi-Fi Direct communication.

16. The operating method of claim 11, wherein the adjusting of the bitrate of the media data based on the difference between the first quantity and the second quantity comprises:
when the difference between the first quantity and the second quantity is greater than or equal to a threshold value, adjusting the bitrate of the media data to decrease; and
when the difference between the first quantity and the second quantity is less than the threshold value, adjusting the bitrate of the media data to increase or maintaining the bitrate of the media data to be unchanged.

17. The operating method of claim 16, wherein the adjusting of the bitrate of the media data based on the difference between the first quantity and the second quantity comprises:
obtaining an adjusted bitrate value based on the difference between the first quantity and the second quantity; and
obtaining encoded media data based on the adjusted bitrate value through an encoder.

18. The operating method of claim 12, further comprising:
obtaining a video packet and an audio packet in the application layer based on the media data;; and
setting an Internet protocol (IP) header field value to distinguish between the video packet and the audio packet,
wherein each of the video packet and the audio packet includes the set IP header field value is stored in a separate buffer.

19. The operating method of claim 18, further comprising:
identifying a first quantity of the video packet and a first quantity of the audio packet separately;
identifying a second quantity of the video packet and a second quantity of the audio packet separately;
based on a difference between the first quantity of the video packet and the second quantity of the video packet, adjusting a bitrate of the video data; and
based on the difference between the first quantity of the audio packet and the second quantity of the audio packet, adjusting a bitrate of the audio data.

20. A non-transitory computer-readable recording medium having a program recorded thereon for causing a computer to execute the operating method of a source device, the operating method comprising:
identifying a first quantity of media packets generated to transmit media data to a display device;
identifying a second quantity of media packets indicating a number of the generated media packets transmitted to the display device, the generated media packets transmitted to the display device through a wireless communication module that supports direct communication with the display device; and
adjusting a bitrate of the media data based on a difference between the first quantity and the second quantity.
